(19) United States
(12) Patent Application Publication
(10) Pub. No.: US 2001/0045917 A1
(43) Pub. Date: Nov. 29, 2001

(54) Edge guard for a signal receiving device deployably mounted to a vehicle

(76) Inventors: Ronald L. Fedder, Coldwater, TN (US); Timothy B. Crowson, Madison, AL (US)

Correspondence Address: Pillsbury Winthrop LLP, Intellectual Property Group, Ninth Floor, 1100 New York Avenue, NW, Washington, DC, 20005-3918, US

(21) Appl. No.: 09/773,634

(22) Filed: Feb. 2, 2001

Related U.S. Application Data
(60) Provisional application No. 60/180,203, filed on Feb. 4, 2000.

(51) Int. Cl. H01Q 15/14

(52) U.S. Cl. 343/912; 343/913

(57) ABSTRACT

The present invention relates to a system for shielding an edge of a satellite antenna from a surface of a vehicle on which the satellite antenna is installed. The system includes a signal reflecting device including a satellite antenna having an edge portion. The edge portion includes a substantially straight edge segment and an edge guard structured to surround the edge segment.

### CROSS-REFERENCE

This application claims the benefit of U.S. Provisional Application No. 60/180,203, filed Feb. 4, 2000, which is incorporated herein by reference.

### BACKGROUND OF THE INVENTION

1. Field of the Invention

The present invention relates to an edge guard for a signal receiving device that is deployably mounted to a vehicle.

2. Description of Related Art

With the increased popularity and availability of satellite-based information and entertainment transmissions, such as satellite-based television programming and internet, satellite antenna's (e.g., dish antennas) for receiving satellite signals are being mounted on mobile vehicles, such as recreational vehicles and semi tractors, to provide satellite signal access for the mobile vehicle.

There are at present a number of commercially available mechanisms for mounting satellite antennas to vehicles. One such mechanism for deployably mounting a satellite antenna to a back surface of a vehicle is disclosed in U.S. Pat. No. 5,961,092, the contents of which are hereby incorporated by reference, and is commercially available from Satellite Mobile Systems, Incorporated of Madison, Ala. under the trade name Polekat™. Another mechanism for deployably mounting a satellite antenna to a vehicle is commercialized by Winegard, Inc. of Burlington, Iowa. Another commercially available mechanism for mounting a satellite antenna to a vehicle has been commercialized by Datron, a division of Transco, Inc. which is based in Simi Valley, Calif., under the trademark “DBS-3000”, “DBS-4000” and “CruiseTV.” Finally, one other commercially available mechanism for mounting a satellite antenna to a vehicle has been commercialized by KVH Industries, Inc., which is based in Middletown, R.I., under the trademark “TracVision”.

Satellite antennas are typically stamped from metal or hard plastic and are coated with a weather resistant material. The hard edges of the antenna are rather sharp and can scratch the expensive surface finish of the vehicle to which the antenna is attached, especially when the satellite antenna is moved with respect to the vehicle surface as it is repeatedly deployed and undeployed or stowed, or due to vibration while the vehicle is in transit.

### SUMMARY OF THE INVENTION

There is subsequently a need for a mechanism to prevent the hard edges of the satellite antenna from scratching the surface finish of the vehicle to which the antenna is attached.

Consistent with the principles of the present invention as embodied and broadly described herein, an exemplary embodiment includes a signal receiving device. The device comprises an antenna having a marginal edge, and an edge guard around the marginal edge.

### BRIEF DESCRIPTION OF THE DRAWINGS

The accompanying drawings, which are incorporated in and constitute a part of this specification, illustrate preferred embodiments of the invention and, together with the description, explain the objects, advantages, and principles of the invention. In the drawings:

FIG. 1 is a perspective view of a mechanism for deployably mounting a satellite antenna to a vehicle, with the antenna in a stowed position;

FIG. 2 illustrates the mechanism of FIG. 1 after deployment of the satellite antenna;

FIG. 3 is a perspective view of a satellite antenna having an edge guard according to the present invention;

FIG. 4 is a side view of the satellite antenna illustrated in FIG. 3; and

FIG. 5 is a cross-section along line 5-5 in FIG. 4.

### DETAILED DESCRIPTION OF PREFERRED EMBODIMENTS

The following detailed description of the present invention refers to the accompanying drawings that illustrate exemplary embodiments consistent with this invention. Other embodiments are possible and modifications may be made to the embodiments without departing from the spirit and scope of this invention. Therefore, the following detailed description is not meant to limit the invention.

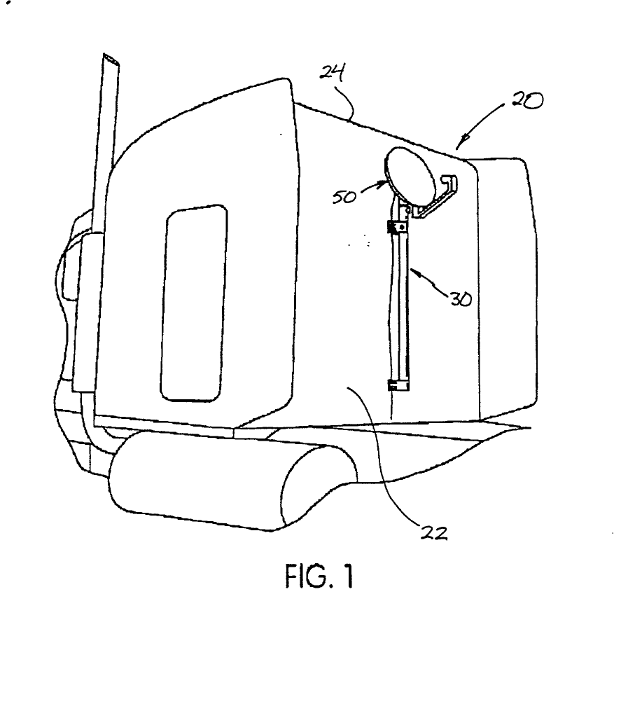

With reference to FIGS. 1-5, an embodiment of an edge guard for a deployable, vehicle-mounted satellite antenna will now be described.

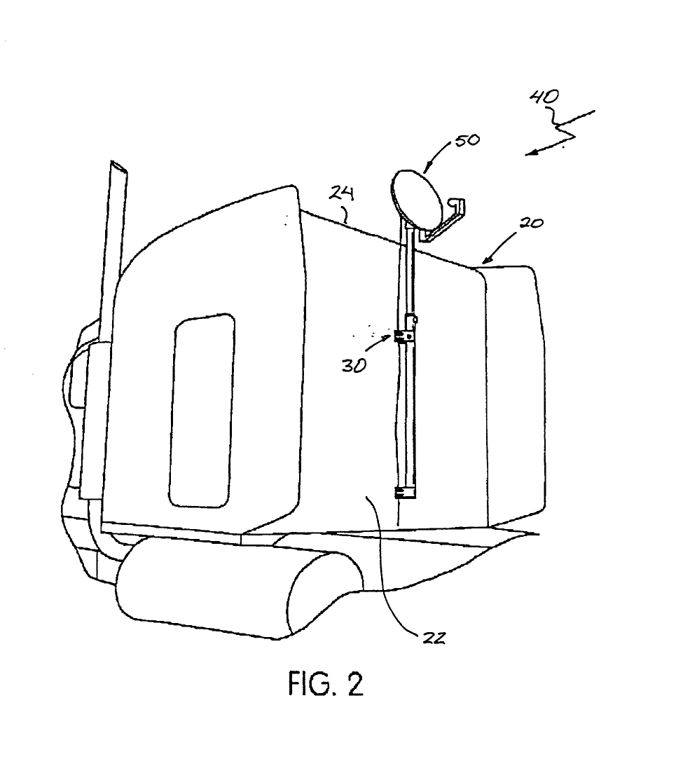

A vehicle, generally indicated at 20, is partially shown in FIGS. 1 and 2. In the exemplary embodiments of the Figures, the vehicle is shown as a semi tractor. A satellite antenna 50 is deployably attached to a back surface 22 of the vehicle 20 by means of a deployable mounting mechanism 30 attached to the back surface 22 of the vehicle 20. In the illustrated embodiment, the deployable mounting mechanism 30 comprises a telescopic pole assembly as is disclosed in U.S. Pat. No. 5,961,092 incorporated above. It will be understood, however, that the edge guard of the present invention can be used in conjunction with any mechanism for deployably mounting a satellite antenna to a vehicle.

FIG. 1 shows the mounting mechanism 30 arranged so that the satellite antenna 50 carried thereby is in a stowed position. That is, the satellite antenna 50 is positioned below a top portion 24 of the vehicle 20. By being stowed below the top portion 24 of the vehicle 20, the satellite antenna 50 is protected from wind and debris during forward movement of the vehicle 20.

In FIG. 2, the mounting mechanism 30 is shown holding the satellite antenna 50 in a deployed position. In the deployed position, the satellite antenna 50 carried by the deployable mounting mechanism 30 is disposed above a top portion 24 of the vehicle 20, so that the antenna 50 is able to receive satellite signals 40.

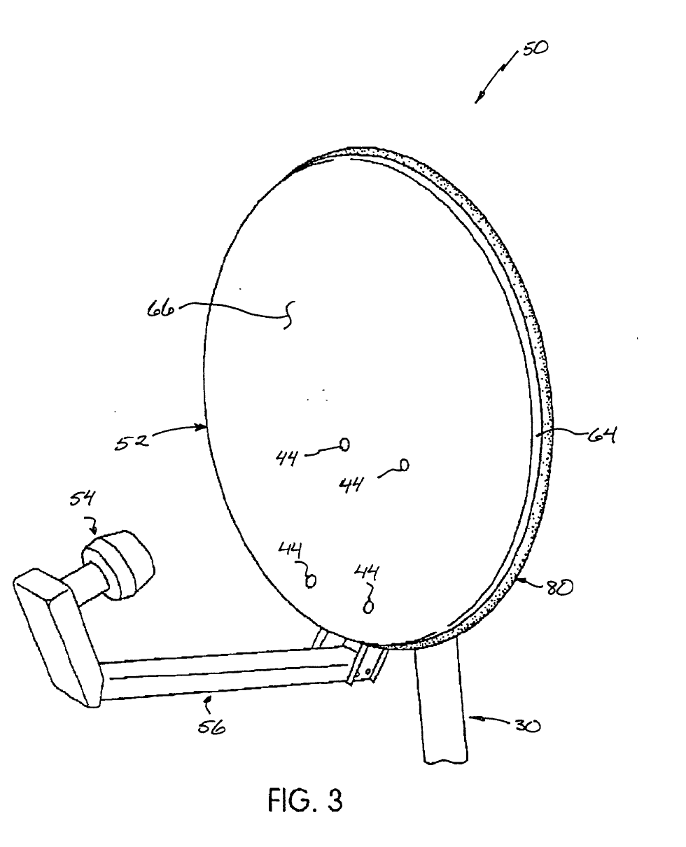

As shown in FIG. 3, the satellite antenna 50 typically includes a focusing/reflecting antenna 52 and a receiver element 54 operatively positioned on a receiver arm 56 so as to be able to receive satellite signals reflected and focused by the antenna 52. The focusing/reflecting antenna 52 includes a curved signal receiving surface 66 and a peripheral portion 64. As will be described in more detail below, an edge guard element 80 covers an edge of the peripheral portion 64.

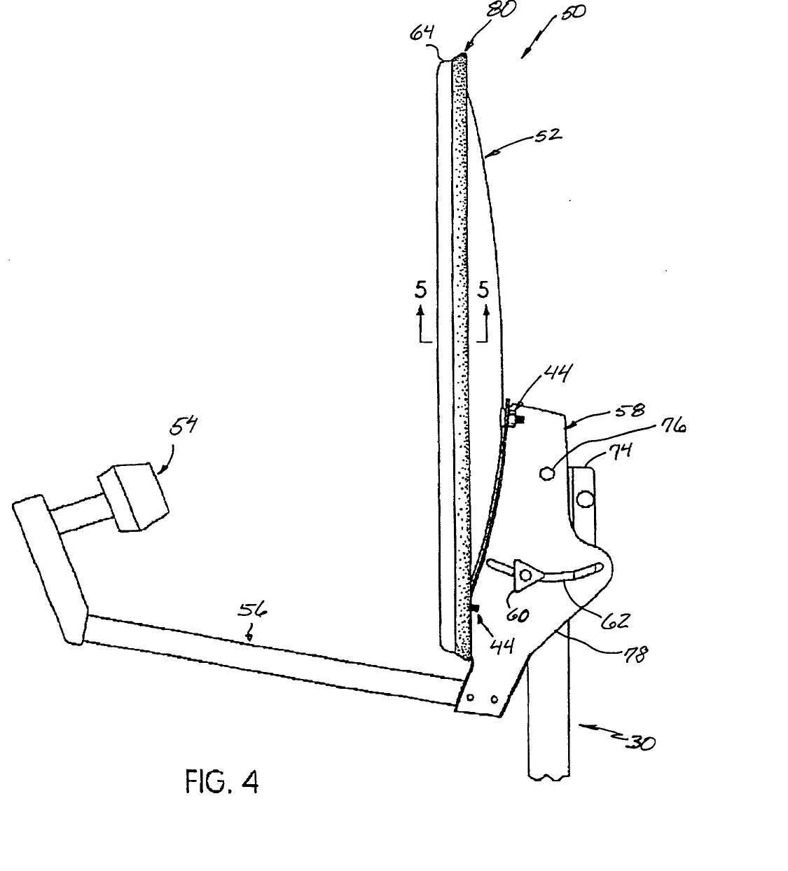

As shown in FIG. 4, the focusing/reflecting antenna 52 is attached to a antenna mounting bracket 58 by means of a series of fasteners 44. In the illustrated embodiment, fasteners 44 comprise carriage bolts and associated nuts. Antenna 52 could also be attached to the bracket 58 by other well-known means such as by rivets, welding, or brazing.

A mechanism by which the elevation angle of the focusing/reflecting antenna 52 can be adjusted is preferably provided. In the illustrated embodiment, a threaded rod (not shown) secured to a portion 74 of the antenna mounting bracket 58 that is fixed with respect to the deployable mounting mechanism 30 extends through an arcuate slot 62 formed in an outer surface of a pivoting portion 78 of the bracket 58. A manually operable threaded element 60 cooperates with the threaded rod extending through the arcuate slot 62. By tightening the threaded element 60, the pivoting portion 78 and the antenna 52 are fixed with respect to the deployable mounting mechanism 30. When the element 60 is loosened, the pivoting portion 78 of the antenna mounting bracket 58 is able to pivot with respect to the deployable mounting mechanism 30 about a pin 76 so that the elevation angle of the antenna 52 can be adjusted. The element 60 can then be retighten to fix the focusing/reflecting antenna 52 in the desired angle. Further details regarding the antenna mounting bracket 58 and the illustrated mechanism for permitting adjustment of the elevation angle of the antenna 52 are disclosed in my copending application entitled “Manually Operable Mechanism for Permitting Elevation Angle Adjustment of the Satellite Antenna”, the contents of which Are hereby incorporated by reference.

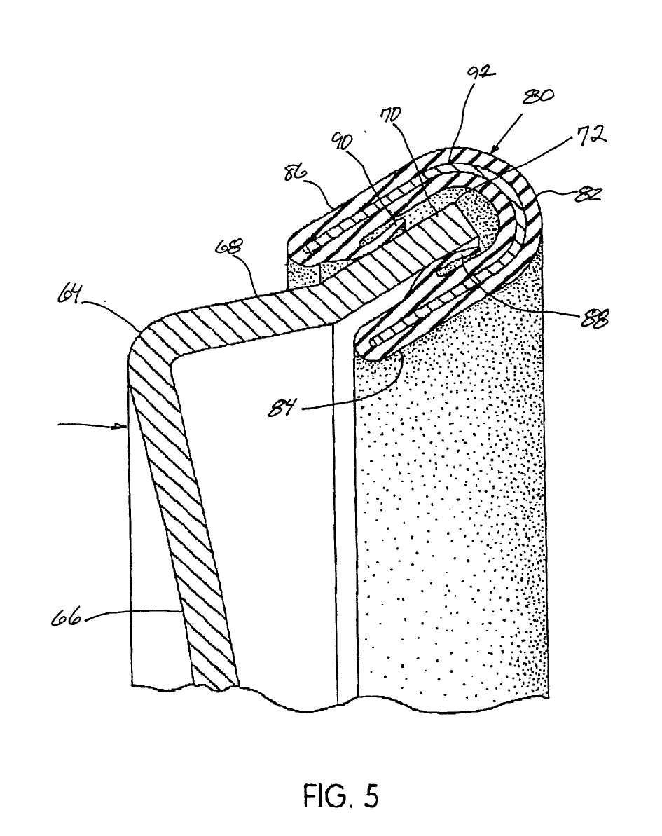

Details of the edge guard element 80 are shown in FIG. 5. As shown in the Figure, the peripheral portion 64 of the focusing/reflecting antenna 52 comprises a flange 68 turned transversely rearwardly from the curved signal receiving surface 66. A marginal edge portion of the transversely turned flange 68 includes an outwardly bent, substantially straight segment 70 terminating in a marginal edge 72. Marginal edge 72 includes relatively sharp edges that can scratch the surface finish of the back surface 22 of the vehicle 20 when the satellite antenna 50 is moved between the stowed position shown in FIG. 1 and the deployed position shown in FIG. 2. To prevent such scratching, an edge guard element 80 is protectively positioned over the marginal edge 72.

As shown in cross-section, the edge guard element 80 comprises a generally U-shaped structure having an inner leg 84 and an outer leg 86 connected by a curve portion 82. The edge guard element 80 is preferably formed of a relatively soft material, such as rubber or an equivalent man-made material. A resilient lip 88 projects outwardly from the inner leg 84 toward the outer leg 86, and a resilient lip 90 projects inwardly from the outer leg 86 toward the inner leg 84 of the edge guard element 80. The resilient lips 88 and 90 are positioned and configured so that they are resiliently compressed when the edge guard element 80 is installed by sliding it over the marginal edge 72 and onto the outwardly bent segment 70 of the peripheral portion 64 of the antenna 52. Being resiliently compressed and being formed from a relatively soft, high friction material, the resilient lips 88 and 90 help secure the edge guard element 80 onto the segment 70 of the antenna 52.

As can be appreciated from FIG. 5, both of the resilient lips 88 and 90 project generally toward the curved portion 82 of the U-shaped edge guard element 80. This shape facilitates installation of the edge guard element 80 over the marginal edge 72 and onto the outwardly bent segment 70 while providing resistance to relative movement of the outwardly bent segment 70 away from the curved portion 82. Thus, the edge guard element 80 can be installed onto segment 70 relatively easily, but cannot as easily be removed from segment 70.

The edge guard element 80 preferably includes a plurality of spaced apart embedded u-shaped clips 92. Clips 92 are preferably formed from a pliable metal material. By squeezing the inner leg 84 and outer leg 86 inwardly toward the outwardly bent segment 70, the clips 92 help retain the edge guard element 80 in this position with the resilient lips 88 and 90 compressed.

The edge guard element 80 may comprise a linear strip of flexible material wrapped around the marginal edge 72 with opposite ends thereof meeting each other. Alternatively, the edge guard element 80 may comprise a formed, continuous loop of material of a size conforming to the diameter of the focusing/reflecting antenna 52. In the preferred embodiment, the edge guard element 80 comprises a length of automotive weather stripping material commercially available from Standard Products Company, Specialty Products Group, of Dearborn, Mich., customer part no. 75000341.

The foregoing description of the preferred embodiments provides an illustration and description, but is not intended to be exhaustive or to limit the invention to the precise form disclosed. Modifications and variations are possible consistent with the above teachings or may be acquired from practice of the invention.

What is claimed is:

1. A signal receiving device comprising:
a antenna having a marginal edge; and
an edge guard around the marginal edge.

2. A signal reflecting device comprising:
an antenna having a substantially straight edge portion; and
an edge guard configured to surround the edge portion.

3. A signal reflecting device according to claim 2, wherein the edge guard is substantially U-shaped.

4. A signal reflecting device according to claim 3, wherein the edge guard comprises:
an inner leg portion;
an outer leg portion positioned substantially parallel to and spaced apart from the inner leg portion; and
a connecting portion to connect the inner leg portion and the outer leg portion;
wherein the inner leg portion, the outer leg portion, and the connecting portions include interior and exterior surfaces.

5. A signal reflecting device according to claim 4, wherein each of the inner and outer leg portions includes a protruding lip disposed along the respective inner surface, each protruding lip being configured to resiliently contact a respective side of the substantially straight segment when the edge guard surrounds the edge portion.

6. A signal reflecting device according to claim 5, wherein the edge guard further comprises a deformable member interposed between all of the interior and exterior surfaces, the deformable member being structured to produce the resilient contact.

7. A signal reflecting device according to claim 6, wherein the deformable member includes at least one metal clip.

8. A signal reflecting device according to claim 2, wherein a diameter of the edge guard corresponds to a diameter of the reflecting device.

9. A edge guard configured for protecting an edge of an object, the edge guard comprising:
an inner leg portion;
an outer leg portion positioned substantially parallel to and spaced apart from the inner leg portion; and
a connecting portion connecting the inner leg portion and the outer leg portion;
wherein the inner leg portion, the outer leg portion, and the connecting portions include interior and exterior surfaces; and
wherein the inner and outer leg portions each includes a protruding lip disposed along the respective interior surface, each of the protruding lips being configured to resiliently contact respective sides of the object.
